(19) United States
(12) Patent Application Publication
(10) Pub. No.: US 2026/0256211 A1
(43) Pub. Date: Sep. 3, 2026

(54) AEROSOL GENERATION DEVICE CAPABLE OF CONTROLLING HEATING TEMPERATURE

(71) Applicant: KT&G CORPORATION, Daejeon (KR)

(72) Inventor: Sung Jong KI, Yuseong-gu (KR)

(73) Assignee: KT&G CORPORATION, Daejeon (KR)

(21) Appl. No.: 18/881,832

(22) PCT Filed: Jun. 16, 2023
(86) PCT No.: PCT/KR2023/008370

§ 371 Date: Jan. 7, 2025

(30) Foreign Application Priority Data
Aug. 3, 2022 (KR) 10-2022-0096634

(51) Int. Cl. A24F 40/57; A24F 40/46; A24F 40/53; A24F 40/60; H05B 3/06

(52) U.S. Cl. CPC A24F 40/57; A24F 40/46; A24F 40/53; A24F 40/60; H05B 3/06

(57) ABSTRACT

The present invention relates to an aerosol generation device including an aerosol generation article insertion part into which an aerosol generation article can be inserted and that includes a first heating unit applying heat to the aerosol generation article, a vaporizing unit that includes an aerosol generating material, a second heating part applying heat to the aerosol generating material, and a temperature sensor confirming a temperature of the second heating part, and a control unit that can control the first heating unit and the second heating unit, respectively.

### TECHNICAL FIELD

The present invention relates to an aerosol generation device. More particularly, the present invention relates to an aerosol generation device capable of controlling heating temperature.

This application claims the benefit of priority based on Korean Patent Application No. 10-2022-0096634, filed on Aug. 3, 2022, the entire disclosure of which is incorporated herein as part of this specification.

### BACKGROUND ART

In recent years, there has been a growing demand for alternative smoking articles that overcome the disadvantages of traditional aerosol generation articles. For example, demand for devices (e.g., an aerosol generation article type electronic cigarette) that generate aerosol by electrically heating an aerosol generation article stick is increasing. Accordingly, research on an electrically heated aerosol generation device and an aerosol generation article stick (or aerosol generation article) applied thereto is being actively conducted.

The aerosol generation device may include a heating unit capable of controlling heating temperature inside the device. The heating unit may control the heating temperature for heating the aerosol generation article, or may control the heating temperature for heating the vaporizing unit. In this case, the heating unit may control the heating temperature inside the aerosol generation device according to user's preference using the aerosol generation device. Alternatively, the heating unit may control the heating temperature under various conditions depending on conditions inside the aerosol generation device.

For example, the vaporizing unit may include an aerosol generating material, and the heating unit may emit the aerosol generating material by applying heat to the aerosol generating material. When the heating unit continues to heat in the vaporizing unit even when all the aerosol generating materials are consumed within the vaporizing unit, damage may occur to the heating unit disposed within the vaporizing unit.

As such, there is a need for additional research and development on specific methods that may automatically or manually control the heating temperature of the aerosol generation device depending on the conditions inside the aerosol generation device.

### PRIOR ART DOCUMENT

### Patent Document

(Patent Document 1) Korean Laid-open Patent Publication No. 10-2022-0008282

### DISCLOSURE

### Technical Problem

As a result of the above research and development, it is an object of the present invention to provide an aerosol generation device capable of controlling internal heating temperature based on stimulation detected by a sensor unit.

### Technical Solution

According to an embodiment of the present invention to resolve the above object, an aerosol generation device capable of controlling heating temperature includes: an aerosol generation article insertion part into which an aerosol generation article is insertable and which includes a first heating unit that applies heat to the aerosol generation article; a vaporizing unit that includes an aerosol generating material, a second heating part applying heat to the aerosol generating material, and a temperature sensor confirming a temperature of the second heating part; and a control unit that controls the first heating unit and the second heating unit, respectively.

In embodiments, when the temperature of the second heating unit confirmed by the temperature sensor increases above a preset temperature, the control unit may heat only the first heating unit among the first heating unit and the second heating unit.

In embodiments, the preset temperature may be 300° C.

In embodiments, the control unit may turn on the first heating unit when the temperature of the second heating unit increases above the preset temperature.

In embodiments, when the temperature of the second heating unit increases above the preset temperature, the control unit may increase the temperature of the first heating unit from the first temperature range to the second temperature range, and the second temperature range may be a higher temperature range than the first temperature range.

In embodiments, the first temperature range may be 120° C. to 200° C., and the second temperature range may be 150° C. to 250° C.

In embodiments, the aerosol generation device may further include a vibration generation unit that generates vibration, wherein the control unit may operate the vibration generation unit when the temperature of the second heating unit increases above the preset temperature.

In embodiments, the aerosol generation device may further include a display unit that displays an image, wherein the control unit may operate the display unit when the temperature of the second heating unit increases above the preset temperature.

In embodiments, the aerosol generation device may further include: a touch detection sensor that detects a user's touch, wherein the touch detection sensor may turn on the first heating unit based on the number of times of the user's touch or duration of the touch.

In embodiments, the aerosol generation device may further include a touch detection sensor that detects a user's touch, wherein the touch detection sensor may increase the temperature of the first heating unit from a first temperature range to a second temperature range based on the number of times of the user's touch or the duration of the touch, and the second temperature range may be a higher temperature range than the first temperature range.

In embodiments, the control unit may lower the heating temperature of the second heating unit when the temperature of the second heating unit confirmed by the temperature sensor increases above a preset temperature.

In embodiments, lowering the heating temperature of the second heating unit may turn off the second heating unit or lower the heating temperature heated by the second heating unit.

In embodiments, the control unit may increase the temperature of the first heating unit when the temperature of the second heating unit increases above the preset temperature, and increasing the heating temperature of the first heating unit may turn on the first heating unit or may further increase the heating temperature at which the first heating unit is heated.

### Advantageous Effects

The aerosol generation device according to the present invention may include a first heating unit disposed in an aerosol generation article insertion part to heat an aerosol generation article, and a second heating unit disposed in a vaporizing unit to heat an aerosol generating material. In this case, the heating temperatures of the first heating unit and the second heating unit may be adjusted respectively, and determined dependently on each other depending on the remaining amount of aerosol generating material or the heating temperature range of the second heating unit, thereby preventing the damage to the aerosol generation device while maintaining the smoker's smoking satisfaction.

### BRIEF DESCRIPTION OF THE DRAWINGS

FIG. 1 is a diagram illustrating an embodiment of an aerosol generation device according to the present invention.

FIGS. 2A and 2B are diagrams illustrating an embodiment of a vaporizing unit included in the aerosol generation device of FIG. 1.

FIG. 3 is a diagram illustrating a temperature range controlled within the aerosol generation device of FIG. 1.

FIG. 4 is a diagram illustrating another embodiment of the aerosol generation device according to the present invention.

FIG. 5 is a diagram illustrating another embodiment of the aerosol generation device according to the present invention.

FIG. 6 is a diagram illustrating another embodiment of the aerosol generation device according to the present invention.

FIG. 7 is a diagram illustrating another embodiment of the aerosol generation device according to the present invention.

### BEST MODE

Hereinafter, the present invention will be described in more detail.

General terms that are currently widely used are selected as terms used in embodiments in consideration of functions in the present invention but may be changed depending on the intention of those skilled in the art or a judicial precedent, the emergence of a new technique, and the like. In addition, in a specific case, the terms arbitrarily chosen by an applicant may exist. In this case, the meaning of such terms will be described in detail in a corresponding description portion of the present invention. Therefore, the terms used in exemplary embodiments of the present invention should be defined on the basis of the meaning of the terms and the contents throughout the present invention rather than simple names of the terms.

Throughout the present specification, unless explicitly described to the contrary, “comprising” any components will be understood to imply the inclusion of other elements rather than the exclusion of any other elements. In addition, the terms “ . . . unit,” “ . . . module,” and the like, described in the specification refer to a processing unit of at least one function or operation and may be implemented by hardware or software or a combination of hardware and software.

Throughout the specification, an “aerosol generating material” means a material capable of generating an aerosol, and may also refer to an aerosol forming substrate. The aerosol may include a volatile compound. The aerosol generating material may be solid or liquid.

For example, the solid aerosol generating material may include a solid material based on tobacco raw materials such as planar leaf tobacco, cut filler, and reconstituted tobacco, and the liquid aerosol generating material may include liquid materials based on nicotine, tobacco extracts, and various flavoring agents. Of course, it is not limited to the above example.

Throughout the specification, an aerosol generation device may be a device that generates an aerosol using an aerosol generating material to generate an aerosol that can be inhaled directly into a user's lung through a user's mouth. For example, the aerosol generation device may be a holder.

Throughout the specification, “puff” refers to the user's inhalation, and the inhalation may refer to a situation where the puff is pulled into a user's oral cavity, nasal cavity, or lung through the user's mouth nose.

Hereinafter, embodiments of the present invention will be described in detail with reference to the accompanying drawings so that those skilled in the art to which the present invention pertains may easily practice the present invention. However, the present invention may be implemented in various different forms, and is not limited to embodiment examples described herein.

Hereinafter, embodiments of the present invention will be described in detail with reference to the drawings.

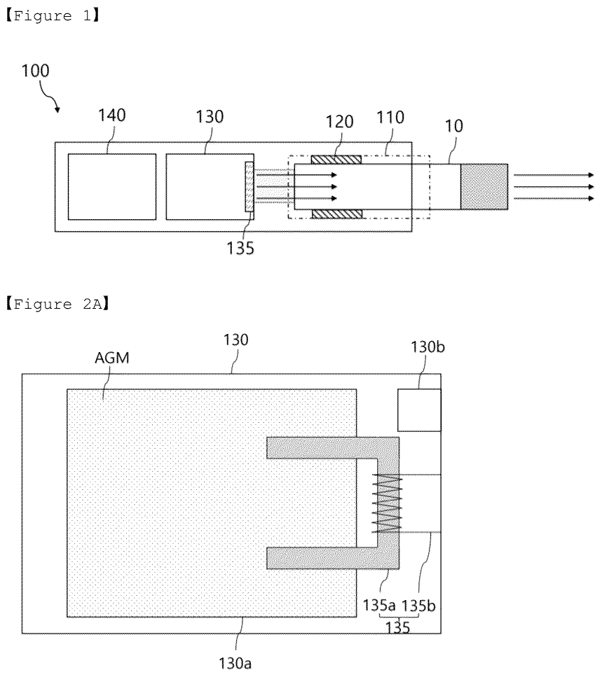

FIG. 1 is a diagram illustrating an embodiment of an aerosol generation device according to the present invention.

Referring to FIG. 1, an aerosol generation device 100 may include an aerosol generation article insertion part 110, a first heating unit 120, a vaporizing unit 130, a second heating unit 135, and a control unit 140. An aerosol generation article 10 may be inserted into the aerosol generation article insertion part 110. In the aerosol generation device 100, only components related to the present embodiment are illustrated. Accordingly, those skilled in the art can easily understand that other general-purpose components in addition to the components illustrated in FIG. 1 may be further included in the aerosol generation device 100. In addition, the aerosol generation device 100 may be in the form of a stick or a holder.

The aerosol generation article insertion part 110 corresponds to one area of the aerosol generation device 100 and may provide a space into which the aerosol generation article 10 is inserted. The aerosol generation article 10 may have a generally known form, and may have a form in which tobacco raw materials are deposited on a heat-conducting material. For example, the heat-conducting material may be a metal foil, such as aluminum foil.

In one embodiment, the first heating unit 120 may heat the aerosol generation article 10 inserted into the aerosol generation article insertion part 110. The heating unit 120 may be, for example, a heater module. The heater module may include a tubular heating element, a plate-shaped heating element, and a needle-shaped or rod-shaped heating element, and may heat the inside and/or outside of the aerosol generation article 10 depending on the shape of the heating element. The first heating unit 120 may generate an aerosol with tobacco flavor by heating the aerosol generation article 10. Accordingly, a user may inhale an aerosol with tobacco flavor by inhaling one end of the aerosol generation article 10 with his/her mouth. The suction power with which the user inhales one end of the aerosol generation article 10 may be maintained within a certain range.

The vaporizing unit 130 may be coupled to the aerosol generation device 100 so that it can be replaced. A second heating unit 135 may be disposed inside the vaporizing unit 130. The second heating unit 135 may be, for example, a heater module. The heater module may include a wick and a vaporizing unit, and the heater module may generate an aerosol by heating the aerosol generating material, which is absorbed through the wick, through the vaporizing unit. The vaporizing unit 130 may generate an aerosol by heating the aerosol generating material stored therein using the second heating unit 135, and the generated aerosol may be released toward the inserted aerosol generation article 10 so that the generated aerosol passes through the aerosol generation article 10 inserted into the aerosol generation article insertion part 110. Therefore, tobacco flavor may be added to the aerosol that passes through the aerosol generation article 10, and the user may inhale an aerosol with tobacco flavor by inhaling one end of the aerosol generation article 10 with his/her mouth. Accordingly, the user may inhale the aerosol generated by the vaporizing unit 130 and the aerosol generated from heating the aerosol generation article 10 together. In this case, the heater module may heat the aerosol generation article 10 at a relatively low temperature. For example, the heater module may heat the aerosol generation article 10 to a temperature of about 40° C. to 200° C. The vaporizing unit 130 used in this specification may be used interchangeably with the terms such as atomizer, atomizer, and cartomizer.

The control unit 140 may control the overall operation of the aerosol generation device 100. Specifically, the control unit 140 may control the operations of the first heating unit 120, the vaporizing unit 130, and the second heating unit 135, as well as other components included in the aerosol generation device 100. In addition, the control unit 140 may confirm the state of each component of the aerosol generation device 100 and determine whether the aerosol generation device 100 is in an operable state. For example, the aerosol generation device 100 may further include a battery, and the control unit 140 may check the charging state of the battery to determine whether the aerosol generation device 100 is in an operable state. s In addition, the aerosol generation device 100 may further include a display unit and a vibration generation unit, and the control unit 140 may confirm the state of the aerosol generation device 100 to operate the display unit and/or the vibration generation unit. In addition, the control unit 140 may control the operation of components that may be included in the aerosol generation device 100.

The control unit 140 may include at least one processor. The control unit may be implemented as an array of a plurality of logic gates or may be implemented as a combination of a general-purpose microprocessor and a memory in which a program executable in the microprocessor is stored. In addition, those skilled in the art may easily understand that the present embodiment may be implemented with other types of hardware.

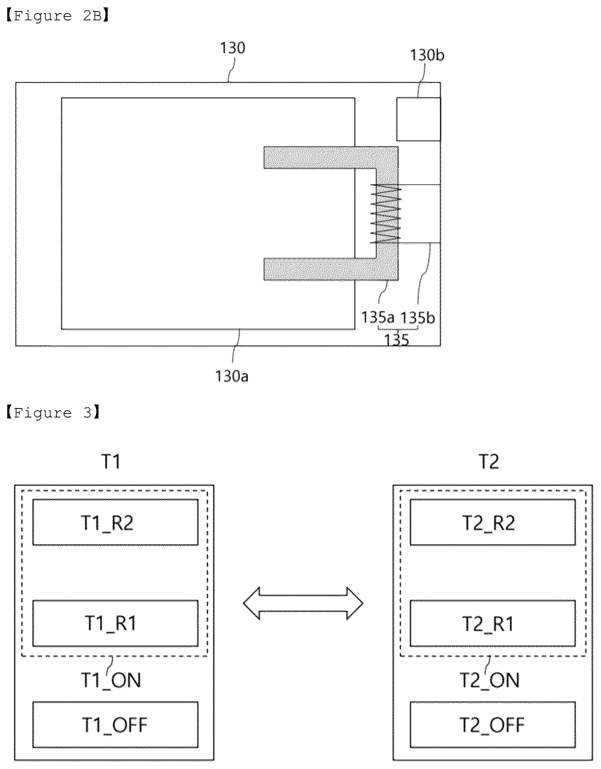

FIGS. 2A and 2B are diagrams illustrating an embodiment of the vaporizing unit included in the aerosol generation device of FIG. 1.

Referring to FIGS. 1 and 2A, the vaporizing unit 130 may include a storage unit 130a, a temperature sensor 130b, and a second heating unit 135. The storage unit 130a may provide a space in which an aerosol generating material (AGM) is stored. The aerosol generating material (AGM) stored in the provided space may be heated by heat provided by the second heating unit 135 and released to the aerosol generation article insertion part 110.

The second heating unit 135 may include a vaporizer 135b and a wick 135a. The wick 135a may absorb the aerosol generating material (AGM) stored in the storage unit 130a. The wick 135a may be made of a material that may absorb a liquid phase through a capillary shape, such as silica, cotton, or bead aggregate. However, this is an example, and the materials constituting the wick 135a are not limited thereto.

The vaporizer 135b may generate the aerosol by vaporizing the aerosol generating material (AGM) absorbed in the wick 135a. In FIG. 2A, the vaporizer 135b is illustrated as an example implemented as a heating element that vaporizes the liquid phase absorbed in the wick 135a through heating, but this is an example and the means for vaporizing the liquid phase is not limited thereto. For example, the vaporizer 135b may also be implemented in the form that vaporizes the aerosol generating material (AGM) through ultrasonic waves.

Referring to FIG. 2B together, when the second heating unit 135 continues to be heated in the state in which the aerosol generating material (AGM) is used up, as the temperature of the second heating unit 135 increases, the damage to the second heating unit 135 may occur. Accordingly, the temperature sensor 130b may determine whether the aerosol generating material (AGM) has been used up by detecting the temperature change of the second heating unit 135. The temperature sensor 130b may transmit a signal to the control unit 140 when the temperature of the second heating unit 135 increases above a preset temperature. The control unit 140 may receive the signal and stop heating the second heating unit 135, thereby preventing the second heating unit 135 from being damaged.

In this way, when the aerosol generating material (AGM) is used up, the aerosol generation device 100 according to the present invention may detect the temperature change of the second heating unit 135 that heats the vaporizing unit 130 and stop heating the second heating unit 135. Thereafter, smoking may proceed only with heating by the first heating unit 120. The first heating unit 120 may start heating after the second heating unit 135 stops heating, or may increase the heating temperature after the second heating unit 135 stops heating. This will be described with reference to the drawings to be described later. Alternatively, when the second heating unit 135 continues to heat, the temperature of the vaporizer 135b may increase and damage may occur in the vaporizer 135b. In this case, it is necessary to heat the remaining aerosol generating material (AGM) to a relatively low temperature. In this case, in order to maintain the user's smoking satisfaction, the amount of aerosol generated and the amount of nicotine transferred may be maintained by increasing the heating temperature of the first heating unit 120.

FIG. 3 is a diagram illustrating a temperature range controlled within the aerosol generation device of FIG. 1.

Referring to FIGS. 1 and 3, a heating temperature T1 of the first heating unit 120 and a heating temperature T2 of the second heating unit 135 may be adjusted dependently on each other. As described above, when the aerosol generating material stored in the vaporizing unit 130 is used up and the temperature of the second heating unit 135 increases above the preset temperature, the aerosol generation device 100 may perform smoking using only the first heating unit 120 among the first heating unit 120 and the second heating unit 135.

In this case, since the aerosol and heat generated from the vaporizing unit 130 are not released toward the aerosol generation article 10 inserted into the aerosol generation article insertion part 110, the user's smoking satisfaction may decrease. Therefore, when the heating of the second heating unit 135 stops, the heating of the first heating unit 120 may start or the heating temperature of the first heating unit 120 may increase, thereby preventing the user's smoking satisfaction from decreasing.

For example, when the heating temperature of the second heating unit 135 changes from on T2_ON to off T2_OFF, the heating temperature of the first heating unit 120 may change from off T1_OFF to on T1_ON. In this case, the heating temperature of the first heating unit 120 may be heated to a first temperature range T1_R1 or to a second temperature range T1_R2.

Alternatively, when the heating temperature of the second heating unit 135 changes from on T2_ON to off T2_OFF, the heating temperature of the first heating unit 120 may increase from a first temperature range T1_R1 to a second temperature range T1_R2.

Alternatively, the second heating unit 135 may lower the heating temperature from a second temperature range T2_R2 to a first temperature range T2_R1. In this case, in order to compensate for the reduced amount of aerosol generation and the heat sensation felt by the smoker, the heating temperature of the first heating unit 120 may change from off T1 OFF to on T1_ON, or increase from the first temperature range T1_R1 to the second temperature range T1_R2.

In this way, the aerosol generation device 100 according to the present invention may perform smoking while maintaining the smoker's smoking satisfaction without damaging the device even when the aerosol is used up.

Turning the first heating unit 120 off T1 OFF may refer to that heating is not performed, heating the first heating unit 120 to the first temperature range T1_R1 may refer to heating to about 120° C. to 200° C., and heating the first heating unit 120 to the second temperature range T1_R2 may refer to heating to about 150° C. to 250° C.

In this case, the maximum temperature at which the first heating unit 120 is heated may be about 350° C., the first temperature range T1_R1 is determined to be about 30% to 60% of the maximum temperature, and the second temperature range T1_R2 may be determined to be about 40% to 70% of the maximum temperature.

Turning the second heating unit 135 off T2_OFF may refer to that the second heating unit 135 does not perform heating, heating the second heating unit 135 to the first temperature range T2_R1 may refer to heating to about 150° C. to 250° C., and heating the second heating unit 135 to the second temperature range T2_R2 may refer to heating to about 200° C. to 300° C.

In this case, the maximum temperature at which the second heating unit 135 is heated may be about 800° C., the first temperature range T2_R1 is determined to be about 15% to 30% of the maximum temperature, and the second temperature range T2_R2 may be determined to be about 25% to 38% of the maximum temperature.

The temperature at which the control unit 140 determines that the temperature of the second heating unit 135 increases above the preset temperature may be about 300° C. That is, the temperature at which the control unit 140 determines that the aerosol generating material stored in the vaporizing unit 130 have been used up may be about 300° C.

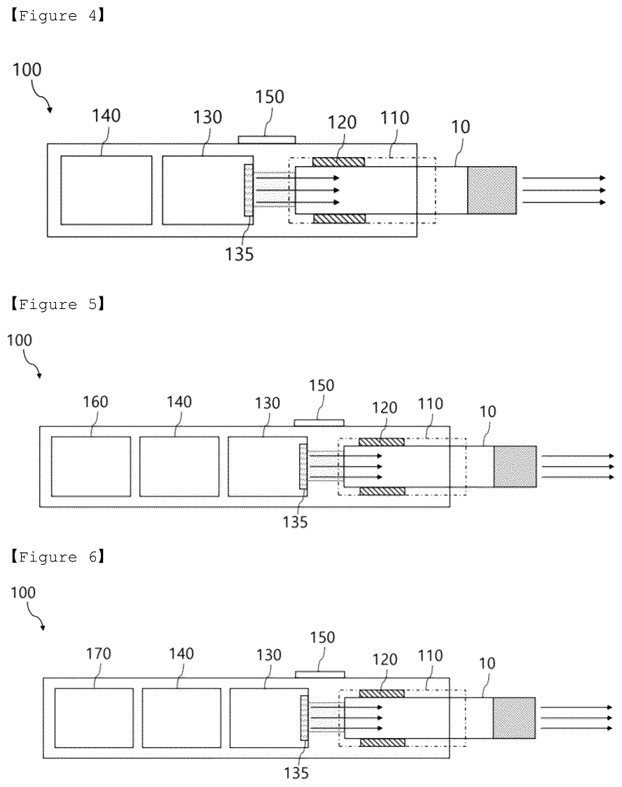

FIG. 4 is a diagram illustrating another embodiment of the aerosol generation device according to the present invention. FIG. 4 may be substantially the same as FIG. 1 except that the sensor 150 is added. Accordingly, description of overlapping configurations will be omitted.

Referring to FIG. 4, the aerosol generation device 100 may further include a sensor 150. The sensor 150 may detect external stimulation. The control unit 140 may control the operation of the aerosol generation device 100 based on the stimulation detected by the sensor 150. In one embodiment, the stimulation may be external temperature, and the sensor 150 may include a temperature sensor to detect the temperature.

In another embodiment, the stimulation may be a user's puff, and the sensor 150 may include a puff detection sensor for detecting the user's puff. The puff detection sensor may detect the number of times of user's puff.

In another embodiment, the stimulation may be a user's touch, and the sensor 150 may include a touch sensor capable of detecting the user's touch. The touch sensor may detect microcurrent generated from a user's hand and may also detect pressure applied by the user's hand. The touch sensor may be a capacitive touch sensor, a resistive touch sensor, or a button-type touch sensor.

In the embodiment of FIG. 1, the control unit 140 of the aerosol generation device 100 detects the temperature change of the vaporizing unit 130 to control the heating of the second heating unit 135, but in the embodiment of FIG. 4, the sensor 150 of the aerosol generation device 100 may control the heating of the second heating unit 135.

For example, after the sensor 150 detects the user's puff, the heating of the second heating unit 135 may be stopped when a preset number of times of puffs has passed. In this case, the preset number of times of puffs may be generally set to the number of times it takes to use up the aerosol generating material. Typically, when the user puffs about 280 to 310 times, the aerosol generating material stored in the vaporizing unit 130 are all used up. Accordingly, the preset number of times may be freely determined between 280 and 310 times. However, this is an example, and the sensor 150 may set the preset number of times of puffs differently depending on the amount of aerosol generating material.

FIG. 5 is a diagram illustrating another embodiment of the aerosol generation device according to the present invention. FIG. 5 may be substantially the same as FIG. 4 except that the vibration generation unit 160 is added. Accordingly, description of overlapping configurations will be omitted.

Referring to FIG. 5, the aerosol generation device 100 may further include a vibration generation unit 160. The vibration generation unit 160 may generate vibration under the control of the control unit 140. When the temperature of the vaporizing unit 130 increases above the preset temperature, the control unit 140 may operate the vibration generation unit 160 to generate the vibration in the aerosol generation device 130. In this way, the user may recognize that the aerosol generating material stored in the vaporizing unit 130 has been used up and stop heating the second heating unit 135 by applying the stimulation to the sensor 150. Alternatively, the control unit 140 may automatically stop heating the second heating unit 135 when the temperature of the vaporizing unit 130 increases above the preset temperature.

Thereafter, the first heating unit 120 may start heating, or the temperature range at which the first heating unit 120 is heating may increase.

For example, when the second heating unit 135 stops heating, the user may stimulate the sensor 150, and the first heating unit 120 may start heating by the stimulation.

Alternatively, when the second heating unit 135 stops heating, the user may stimulate the sensor 150, and the first heating unit 120 may increase the temperature for heating the aerosol generation article 10 by the stimulation.

When the amount of aerosol generated increases, the user may lower the temperature of the second heating unit 135 by stimulating the sensor 150. When the temperature of the second heating unit 135 is lowered, the amount of nicotine transferred through the aerosol generation article 10 may be reduced. Accordingly, the user may increase the temperature of the first heating unit 120 by stimulating the sensor 150.

When the sensor 150 is a touch sensor, the heating temperature of the first heating unit 120 and the second heating unit 135 may be adjusted according to the number of times the touch sensor is touched. For example, when the user touches the touch sensor an odd number of times, the heating temperature of the second heating unit 135 may decrease or turn off, and when the user touches the touch sensor an even number of times, the temperature of the first heating unit 120 may increase.

Alternatively, when the user touches the touch sensor once, the temperature control f the second heating unit 135 is activated, and as the time the user touches the touch sensor increases, the heating temperature of the second heating unit 135 may decrease and then turn off. When the user touches the touch sensor twice, the temperature control of the first heating unit 120 is activated, and as the time the user touches the touch sensor increases, the heating temperature of the first heating unit 120 may increase.

Alternatively, the vibration generation unit 160 may generate vibration when the control unit 140 stops heating the second heating unit 135. In this case, the user may increase the heating temperature of the first heating unit 120 by touching the touch sensor. For example, as the number of times the user touches the touch sensor increases, the heating temperature of the first heating unit 120 may increase. Alternatively, as the number of times the user touches the touch sensor increases, the heating temperature of the first heating unit 120 may increase.

However, this is only an example for convenience of description, and the temperature may be adjusted by various stimulations. In addition, the temperature ranges of the first heating unit 120 and the second heating unit 135 may be combined in various ways other than the combinations described above.

FIG. 6 is a diagram illustrating another embodiment of the aerosol generation device according to the present invention. FIG. 6 may be substantially the same as FIG. 4 except that the display unit 170 is added. Accordingly, description of overlapping configurations will be omitted.

Referring to FIG. 6, the aerosol generation device 100 may further include a display unit 170. When the heating temperature of the second heating unit 135 increases above the preset temperature, the control unit 140 may operate the display unit 170 to notify the user. In this case, the control unit 140 may notify the user after automatically stopping the second heating unit 135, or may notify the user without stopping the operation of the second heating unit 135. The display unit 170 may emit light to notify the user. For example, the display unit 170 may notify the user through a still image or video. This may be operated differently depending on the user's preference using the aerosol generation device 100.

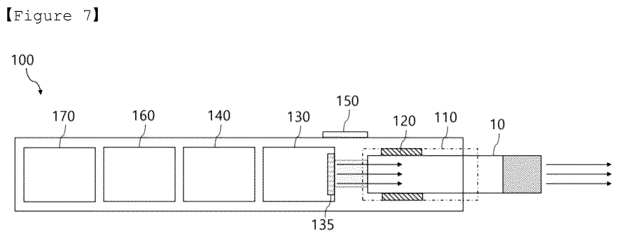

FIG. 7 is a diagram illustrating another embodiment of the aerosol generation device according to the present invention. FIG. 7 may be substantially the same as FIG. 4 except that the vibration generation unit 160 and the display unit 170 are added. Accordingly, description of overlapping configurations will be omitted.

Referring to FIG. 7, the aerosol generation device 100 may further include a vibration generation unit 160 and a display unit 170. When the heating temperature of the second heating unit 135 increases above the preset temperature, the control unit 140 may simultaneously operate the vibration generation unit 160 and the display unit 170 to notify the user. In this case, the control unit 140 may notify the user after automatically stopping the second heating unit 135, or may notify the user without stopping the operation of the second heating unit 135. This may be operated differently depending on the user's preference using the aerosol generation device 100.

Although the present invention has been described in relation to the above-described preferred embodiments, various modifications and alterations may be made without departing from the gist and scope of the present invention. Accordingly, these modifications and alterations fall within the scope of the claims as long as they belong to the gist of the present invention.

### DESCRIPTION OF REFERENCE SIGNS

10: Aerosol generation article
100: Aerosol generation device
110: Aerosol generation article insertion part
120: First heating unit
130: Vaporizing unit
135: Second heating unit
135a: Wick
135b: Vaporizer
140: Control unit
150: Sensor
160: Vibration generation unit
170: Display unit
130a: Storage unit
130b: Temperature sensor
AGM: Aerosol generating material

1. An aerosol generation device capable of controlling heating temperature, comprising:
an aerosol generation article insertion part into which an aerosol generation article is insertable and which includes a first heating unit that applies heat to the aerosol generation article;
a vaporizing unit that includes an aerosol generating material, a second heating part applying heat to the aerosol generating material, and a temperature sensor confirming a temperature of the second heating part; and
a control unit that controls the first heating unit and the second heating unit, respectively.

2. The aerosol generation device of claim 1, wherein when the temperature of the second heating unit confirmed by the temperature sensor increases above a preset temperature, the control unit heats only the first heating unit among the first heating unit and the second heating unit.

3. The aerosol generation device of claim 2, wherein the preset temperature is 300° C.

4. The aerosol generation device of claim 2, wherein the control unit turns on the first heating unit when the temperature of the second heating unit increases above the preset temperature.

5. The aerosol generation device of claim 2, wherein when the temperature of the second heating unit increases above the preset temperature, the control unit increases the temperature of the first heating unit from a first temperature range to a second temperature range, and
the second temperature range is a higher temperature range than the first temperature range.

6. The aerosol generation device of claim 5, wherein the first temperature range is 120° C. to 200° C., and the second temperature range is 150° C. to 250°C.

7. The aerosol generation device of claim 2, further comprising:
a vibration generation unit that generates vibration,
wherein the control unit operates the vibration generation unit when the temperature of the second heating unit increases above the preset temperature.

8. The aerosol generation device of claim 2, further comprising:
a display unit that displays an image,
wherein the control unit operates the display unit when the temperature of the second heating unit increases above the preset temperature.

9. The aerosol generation device of claim 7, further comprising:
a touch detection sensor that detects a user's touch,
wherein the touch detection sensor turns on the first heating unit based on the number of times of the user's touch or a duration of the touch.

10. The aerosol generation device of claim 7, further comprising:
a touch detection sensor that detects a user's touch,
wherein the touch detection sensor increases the temperature of the first heating unit from a first temperature range to a second temperature range based on the number of times of the user's touch or the duration of the touch, and
the second temperature range is a higher temperature range than the first temperature range.

11. The aerosol generation device of claim 1, wherein the control unit lowers the heating temperature of the second heating unit when the temperature of the second heating unit confirmed by the temperature sensor increases above a preset temperature.

12. The aerosol generation device of claim 11, wherein lowering the heating temperature of the second heating unit may turn off the second heating unit or lowers a heating temperature heated by the second heating unit.

13. The aerosol generation device of claim 11, wherein the control unit increases the temperature of the first heating unit when the temperature of the second heating unit increases above the preset temperature, and
increasing the heating temperature of the first heating unit turns on the first heating unit or further increases a heating temperature at which the first heating unit is heated.
